(19) United States
(12) Patent Application Publication
(10) Pub. No.: US 2004/0192336 A1
(43) Pub. Date: Sep. 30, 2004

(54) Device and method for establishing a wireless communication link by a wireless communication device having more than one transceiver

(76) Inventor: James Allen Walby, Delavan, WI (US)

Correspondence Address: MOTOROLA, INC., 1303 EAST ALGONQUIN ROAD, IL01/3RD, SCHAUMBURG, IL, 60196

(21) Appl. No.: 10/305,208

(22) Filed: Nov. 26, 2002

(51) Int. Cl. H04Q 7/20

(52) U.S. Cl. 455/456.1; 455/552.1

(57) ABSTRACT

A wireless communication device (22) that comprises a first transceiver (40), a second transceiver (42), a positioning unit (44), a memory (46), and a controller (48). The first transceiver (40) operates according to a first wireless communication protocol. The second transceiver (42) operates according to a second wireless communication protocol. The positioning unit (44) determines a location of the wireless communication device (22). The memory (46) stores a database of the geographic coverage areas for communicating with remote base stations that operate according to the first wireless communication protocol. The controller (48) is configured to select between the first transceiver (40) and the second transceiver (42) when initially attempting to establish a wireless communication link. In particular, the selection between the first transceiver (40) and the second transceiver (42) is based on the determined location of the wireless communication device (22) from the positioning unit (44) and the geographic coverage areas in the database that is stored in the memory (46). There are also methods of performing these functions in the wireless communication device (22).

### FIELD OF THE INVENTION

This invention in general relates to a device and method for establishing a wireless communication link by a-wireless communication device having more than one wireless transceiver and, more particularly, to a device and method that uses position information and geographic network coverage information to select a transceiver when establishing the wireless communication link.

### BACKGROUND OF THE INVENTION

There is an ever-increasing demand for wireless communication and convenience. Wireless subscribers desire to have access to information at any time and any place. Wireless subscribers also desire to be able to control other mechanical and electronic devices through one wireless device in an efficient and cost-effective manner. One of the fastest growing markets for providing wireless services is known as “Telematics” and entails delivering a wide spectrum of information and services via wireless links to vehicle-based subscribers. In addition to hands-free voice calls, the type of information and services anticipated for Telematics include emergency services such as collision notification and roadside assistance. Telematics may also include other services such as navigation, route guidance, remote-door unlocking, traffic information, weather information, and points of interest.

A wireless communication device, such as the ones anticipated for Telematics applications, may be equipped with multiple wireless transceivers, each operating according to a different wireless communication protocol. One transceiver is typically programmed as a primary transceiver so that the device will initially attempt each call or message according to a “preferred” wireless communication protocol. However, problems exist with this approach. For instance, the device may be locked for a period of time, or a specified number of tries, while attempting to place a call through the primary transceiver. Delays will occur if the device is not within the coverage area of the preferred wireless communication protocol. The user will be forced to wait while the device is attempting to register with a cellular service and until the device finally registers the call through a secondary transceiver. This is particularly undesirable when the call relates to an emergency. It is also undesirable if the device is a portable wireless communication device because it is an extra drain to the power supply.

Moreover, a wireless communication device may need to transmit data messages. The transmission of data may require further considerations when the wireless communication device has more than one transceiver. Each wireless communication protocol may be capable of using several different types of bearer services for the transmission of data, each having varying transmission rates and costs. The ability to use a particular data bearer service may be affected by the geographic location of the wireless device.

In conventional systems, the data bearer service is defined and selected prior to transmittal of the message and are indifferent to the type of data contained in the message. Moreover, once defined and selected, the application is locked to a particular bearer service. For example, the subscriber may attempt to transmit the data message a fixed number of times until it gets an acknowledgement that the data message was received by the service center. The problem with this approach is that the subscriber may be in an area of limited data transmission capability and the transmission of the data may be severely delayed until it can find a suitable data bearer service.

Accordingly, there is a need to provide an improved device and method for establishing wireless communication links for voice calls and the transmittal of data messages by a wireless communication device having more than one wireless transceiver. It is, therefore, desirable to provide an improved device and method to overcome or minimize most, if not all, of the preceding problems.

### BRIEF DESCRIPTION OF THE DRAWINGS

FIG. 1 is a top-level block diagram of one embodiment of a system of the present invention having a wireless communication device and a service center;

FIG. 2 is a block diagram of one embodiment of a wireless communication device for the system in FIG. 1;

FIG. 3 is a flow diagram illustrating one embodiment a method in a wireless communication device for selecting between a first and second transceiver;

FIG. 4 is a table illustrating one embodiment of a database having information regarding the geographic coverage areas for communicating with base stations that operate according to a first wireless communication protocol;

FIG. 5 is a schematic representation of one embodiment of geographic coverage areas for communicating with base stations that operate according to a first wireless communication protocol;

FIG. 6 is a table illustrating another embodiment of a database having information regarding the geographic coverage areas for communicating with base stations that operate according to a first wireless communication protocol;

FIG. 7 is a schematic representation of another embodiment of geographic coverage areas for communicating with base stations that operate according to a first wireless communication protocol;

FIG. 8 is a table illustrating another embodiment of a database having information regarding the geographic coverage areas for communicating with base stations that operate according to a first wireless communication protocol;

FIG. 9 is a flow diagram illustrating another embodiment of a method in a wireless communication device for selecting between a first and second transceiver and, if applicable, the selection of a data bearer service;

FIG. 10 is a table illustrating another embodiment of a database having information regarding the geographic coverage areas for communicating with base stations that operate according to a first wireless communication protocol, including both voice and data communications;

FIG. 11 is a flow diagram illustrating another embodiment of a method in a wireless communication device for selecting to place a call between a first and second transceiver and, if applicable, the selection of a data bearer service; and

FIG. 12 is a table illustrating another embodiment of a database having information regarding the geographic coverage areas for communicating with base stations that operate according to a first and second wireless communication protocol, including both voice and data communications.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is device and method for establishing a wireless communication link in a wireless communication device having more than one wireless transceiver. The device and method improves the time to place a call or transmit a data message. To this end, in one embodiment there is a wireless communication device that comprises a first transceiver, a second transceiver, a positioning unit, a memory, and a controller. The first transceiver operates according to a first wireless communication protocol. The second transceiver operates according to a second wireless communication protocol. The positioning unit determines a location of the wireless communication device. The memory stores a database of the geographic coverage areas for communicating with remote base stations that operate according to the first wireless communication protocol. The controller is configured to select between the first transceiver and the second transceiver when initially attempting to establish a wireless communication link. In particular, the selection between the first transceiver and the second transceiver is based on the determined location of the wireless communication device from the positioning unit and the geographic coverage areas in the database that is stored in the memory.

The geographic coverage areas in the database may include at least one super coverage area to reduce the amount of data stored in the database. For instance, the super coverage area could be circular in shape and be representative of a combined coverage area from a plurality of cellular base stations that operate according to a first wireless communication protocol. The super coverage area could also be irregular in shape and be representative of a combined coverage area from a plurality of cellular base stations that operate according to a first wireless communication protocol. The geographic coverage areas in the database are capable of being updated by a remote service center.

In a further embodiment, the controller may also determine whether a user is attempting to place a voice call or transmit a data message. Here, the database stored in memory may further include information regarding the geographic coverage areas for communicating data messages over a plurality of data bearer services. The controller would select at least one data bearer service based on the determined location of the wireless communication device and the geographic coverage areas of the data bearer services. The controller may further determine whether a particular data message includes high-priority data, such as an emergency call. The selection of the data bearer service would then be further based on the highest available transmission rate within a geographic coverage area.

Another embodiment includes a wireless communication device comprising a first and second transceiver, a positioning unit, a memory, and a means for selecting between the first and second transceivers. Each of the first and second transceivers operate according to a different wireless communication protocol. The positioning unit determines a location of the wireless communication device. The memory stores information regarding the geographic coverage areas for communicating with remote base stations that operate according to at least one of the wireless communication protocols. The means for selecting between the first and second transceivers occurs when the wireless communication device needs to establish a wireless communication link. The selection means is based on the location of the wireless communication device and based on the information stored in the memory regarding the geographic coverage areas for communicating with remote base stations that operate according to at least one of the wireless communication protocols.

A further embodiment includes a method in a wireless communication device that has a first transceiver and a second transceiver. Each transceiver operates according to a different wireless communication protocol. The method comprises the steps of: determining whether a wireless communication link needs to be established by the wireless communication device; determining the location of the wireless communication device when it is determined that a wireless communication link needs to be established; accessing a memory in the wireless communication device to obtain information regarding geographic coverage areas for communicating with remote base stations that operate according to at least one of the wireless communication protocols; and selecting to establish the wireless communication link through either the first transceiver or the second transceiver based on the location of the wireless communication device and based on the information regarding the geographic coverage areas for communicating with the remote base stations that operate according to at least one of the wireless communication protocols.

The method may further include the steps of: determining whether a user is attempting to place a voice call or transmit a data message; accessing the memory in the wireless communication device to obtain information regarding geographic coverage areas for communicating data messages over a plurality of data bearer services; and selecting between a plurality of data bearer services based on the location of the wireless communication device and based on the information regarding the geographic coverage areas for communicating data messages over a plurality of data bearer services. The method may further include the steps of: determining whether a data message including high-priority data; and selecting between a plurality of data bearer services further based on the highest available transmission rate within a geographic coverage area if the data message is determined to include high-priority data.

In a further embodiment, there is a wireless communication device comprising at least one transceiver, a positioning unit, a memory, and a controller. The transceiver operates according to a first bearer service and a second bearer service. The positioning unit determines a location of the wireless communication device. The memory contains information relating to geographic coverage areas for at least the first bearer service. The controller is configured to select between the first bearer service and the second bearer service when attempting to transmit a data message. The controller selecting between the two bearer service based on the determined location of the wireless communication device and based on the information in the memory relating to geographic coverage areas for the first bearer service.

For the purposes of illustration and description, an example of a wireless communication device in a vehicle will be used. However, the present invention is not limited to wireless communication devices in vehicles but may also apply to other communication devices that contain more than one wireless transceiver such as cellular phones, personal digital assistants (PDAs) and other wireless devices. One of ordinary skill in the art having the benefit of this disclosure will realize that the devices and procedures described herein for establishing a wireless communication link could be used in other applications.

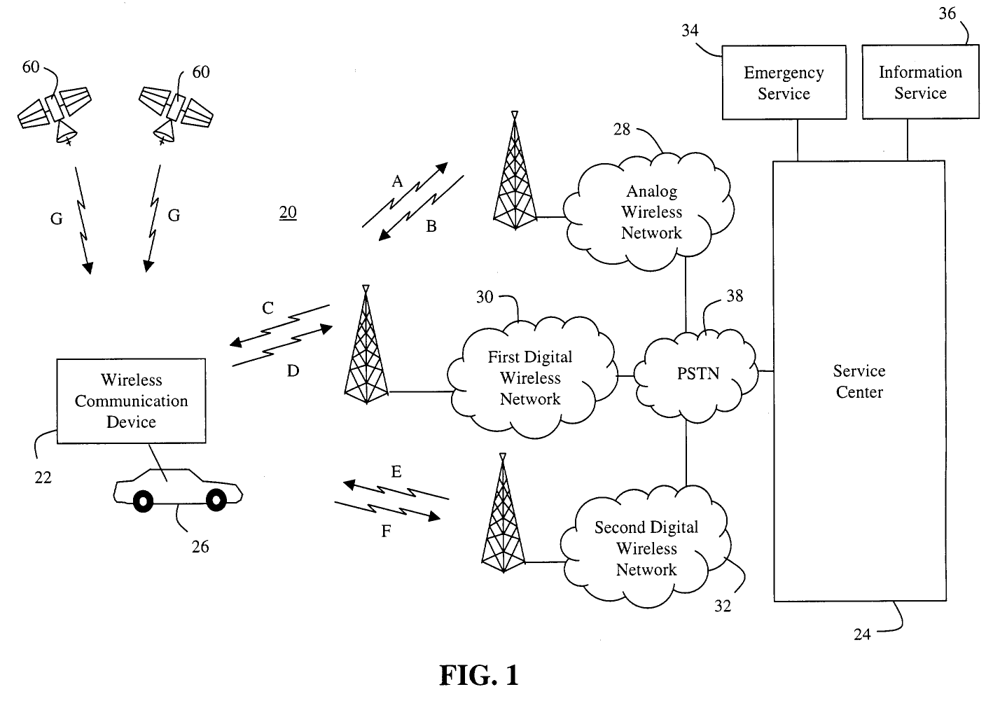

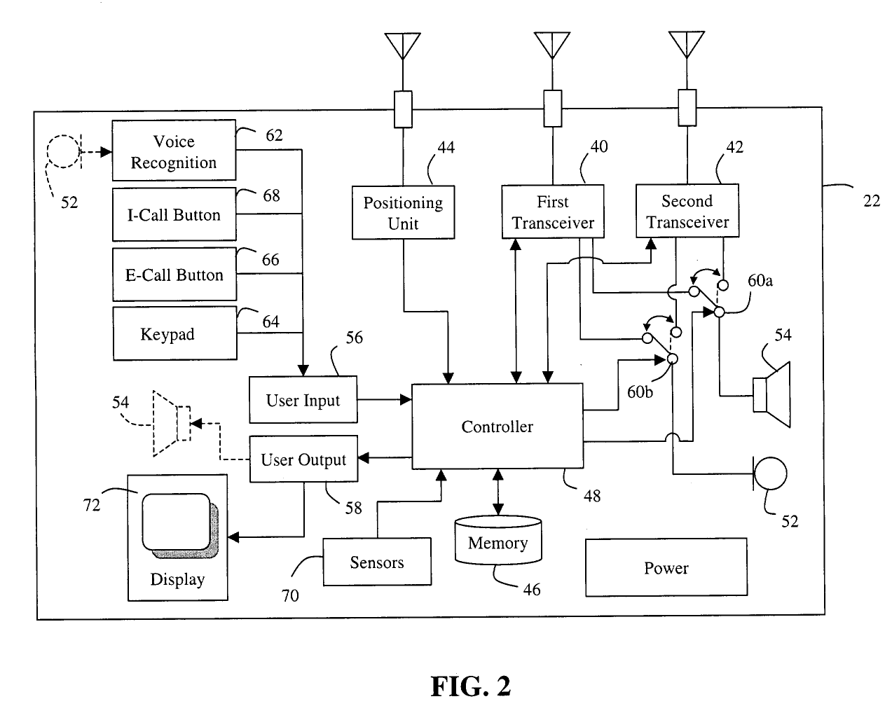

To that end, turning to the drawings, FIG. 1 illustrates a top-level block diagram of a communication system 20 for the present invention. Generally, the communication system 20 may include a wireless communication device 22, wireless networks 28, 30, 32, public land networks 38, and a service center 24. In one embodiment, the wireless communication device 22 is incorporated into a vehicle 26. Although only one wireless communication device 22 and service center 24 are shown, the invention can include any number of these elements interoperating with each other. The components and functions of the wireless communication device 22 and service center 24 are described further below in relation to FIGS. 2-12 for the purpose of illustrating the present invention.

Referring initially to FIG. 1, in the communication system 20, the wireless communication device 22 may attempt to establish a wireless communication link with the service center 24, or other destination, for the purpose of placing a voice call or for the purpose of transmitting a data message. The wireless communication links are illustrated in FIG. 1 by communication arrows A-F. The wireless communication links A-F may be divided into individual sets (A-B, C-D, E-F) for different types of wireless communication protocols. For instance, the wireless communication device 22 may include a wireless transceiver that is capable of establishing a wireless communication link A-B through an analog wireless network 28. This may include a transceiver that operates according to a wireless communication protocol such as the Advanced Mobile Phone System (AMPS). The wireless communication device 22 may also include wireless transceivers that are capable of establishing wireless communication links C-D and E-F through a first digital wireless network 30 and/or a second digital wireless network 32. This may include a transceiver that operates according to a wireless communication protocol such as a Code Division Multiple Access (CDMA) protocol or a Time Division Multiple Access (TDMA) protocol. The wireless network 28, 30, 32 may then communicate with other communications systems, such as a public switched telephone network (PSTN) 38, to interface with a destination like a service center 24.

Moreover, each wireless communication protocol may support different types of data bearer services for the transmission of data messages. For instance, some of the existing bearer services for transmitting data over wireless communications include, but are not limited to, general packet radio service (GPRS), short message service (SMS), circuit switched data service (CSD), and high-speed circuit switched data service (HSCSD). In particular, GPRS is a bearer service that allows the transmission of high-speed data over existing digital communication networks such as the Global System for Mobile Communications (GSM) protocol. GPRS supports the Internet Protocol (IP). This allows the wireless communication device 22 to have access to Internet information and applications. GPRS is a type of virtual connection that allows the user to always be connected to a network. The transmission rate of GPRS is over about 64 kbits/sec. Currently, however, the transmission cost of GPRS is typically based on the amount of data that is transmitted and may be more costly compared to other bearer services.

SMS is a bearer service that allows the transmission of data over several types of existing protocols such as GSM, Code Division Multiple Access (CDMA), and Time Division Multiple Access (TDMA). SMS enables a wireless communication device 22 to transmit short data messages to the service center 24. The time to transfer data in SMS is not as good as transferring data in GPRS. Yet, the transmission cost of transmitting data using SMS is cheaper than GPRS.

CSD is a bearer service that allows the transmission of data over several types of existing protocols such as GSM, CDMA, TDMA, and Advanced Mobile Phone System (AMPS). When transmitting over an analog communication network (such as AMPS), the wireless communication device 22 will need a data modem for the wireless transceiver. The transmission rate of CSD is about 9.6 kbits/sec. Currently, the transmission cost of transmitting data using CSD is cheaper than GPRS. HSCSD is an enhancement of CSD to allow the transmission of data over existing protocols such as GSM. One enhancement includes a new coding scheme with less error protection capabilities. This allows the transmission rate to be increased from about 9.6 kbits/sec to 14.4 kbits/sec. Another enhancement includes providing up to four time slots for a single data call. This allows transmission rates from 38.4 kbits/sec to 57.6 kbits/sec (depending on whether the bearer is at 9.6 kbits/sec or 14.4 kbits/sec). Currently, however, the transmission cost of transmitting data via HSCSD is more expensive compared to other bearer services such as SMS or CSD.

The above described wireless communication protocols and data bearer services are merely representative of existing protocols and bearer services that could be used in the present invention. In other embodiments, other bearer services could be used depending on the implementation and geographic location such as those anticipated for digital protocols of W-CDMA/UMTS (Wideband Code Multiple Access/Universal Mobile Telecommunications System) and cdma2000. The attempt to establish a wireless communication link by the wireless communication device 22 with the service center 24 for the purpose of placing a voice call, or for the purpose of transmitting a data message, will now be described generally although a more detailed description is provided after the general discussion.

Referring to FIGS. 1 and 2, in one embodiment, a wireless communication device 22 may comprise a first transceiver 40, a second transceiver 42, a positioning unit 44, a memory 46, a controller 48. The wireless communication device 22 may further include a microphone 52 and speaker 54 for voice calls as well as a user input means 56 and an user output means 58. The wireless communication device 22 may further be connected to various subsystems of the vehicle 26 for remote control from the service center 24. For instance, one of the Telematics applications may permit remote unlocking of doors.

In general, the wireless communication device 22 attempts to place a voice call or transmit a data message to the service center 24 or other destination using either the first transceiver 40 or the second transceiver 42. Each transceiver 40, 42 operates according to a different wireless communication protocol technology. The selection of the transceiver 40, 42 will be explained in more detail below but will generally depend on the location of the wireless communication device 22 (determined by the positioning unit 44) and the geographic coverage area for fixed base stations (stored in memory 46) that operate according to at least one of the wireless communication protocols.

Depending on the particular implementation, the first and second transceivers 40, 42 may be an integral part of the vehicle 26. Alternatively, one of the first or second transceivers 40, 42 may be separate component such as a portable cellular or Personal Communication System (PCS), a pager, or a hand-held computing device such as a personal digital assistant (PDA) that is docked or otherwise connected to a wireless communication device 22 in the vehicle 26.

The first and second transceivers 40, 42 include a transmitter function to transmit voice and data messages via a wireless communication protocol such as AMPS, CDMA, GSM or TDMA. The wireless communication device 22 may also be configured to transmit by other wireless communications such as satellite communications. As explained above, the transmitter may be configured to establish wireless communication links for voice calls and/or data messages. If the wireless communication device 22 is configured to send data messages over an analog protocol, one of the transceivers will need a data modem.

The first and second transceivers 40, 42 also include a receiver function to receive and decode voice calls and data messages from the service center 24 or other sources. The receiver may be configured to receive data and voice calls through a wireless communication protocol such as CDMA, GSM, TDMA, or AMPS. The receiver may also be configured to receive other types of wireless communications such as those transmitted by satellites.

In one embodiment, the controller 48 in the wireless communication device 22 receives position data from the positioning unit 44. The position data received from the positioning unit 44 relates to a current geographic location of the wireless communication device 22. The location of the wireless communication device 22 is important in the present invention for the selection between the first transceiver 40 and the second transceiver 42. The location of the wireless communication device 22 may also be important in several wireless applications. For example, when an emergency exists, a message to the service center 24 should contain location data of the wireless communication device 22 in addition to other data about the emergency. Additionally, when a user requests navigation services, the message may contain data on the current location of the wireless communication device 22 to assist in generating a navigation route to a desired location.

In one embodiment, the positioning unit 44 may include a global positioning system (GPS) receiver. A plurality of satellites 60 that orbit the earth transmit radio signals G to the GPS receiver. The radio signals G are pseudo-random signals that contain information modulated by a pseudo-random code. The GPS receiver in the positioning unit 44 is able to receive and process the satellite radio signals to calculate position and time. Conventional GPS receivers need to track at least four satellites of the GPS constellation in order to compute a GPS receiver's position and time. An almanac is stored in the positioning unit 44 to help identify visible satellites and to track satellite orbits. Locally generated pseudorandom noise codes are generated within the positioning unit 44 and compared to the received satellite signals. From the compared signals, the positioning unit 44 generates measurement data that reflects travel times of the received satellite signals. Knowing the travel times of the satellite signals allows the positioning unit 44 to compute distances between each satellite and the positioning unit 44. The positioning unit 44 may then compute a position solution that can be reported to the controller 48.

The controller 48 in the wireless communication device 22 also accesses memory 46 to obtain information from a database containing the geographic coverage areas for communicating with fixed base stations that operate according to at least one of the wireless comrnunication protocols for the first transceiver 40 or the second transceiver 42. Depending on the location of the wireless communication device 22 and the information contained in the database of geographic coverage areas, the controller 48 then determines whether to establish a voice communication link through either the first transceiver 40 or the second transceiver 42.

The format of suitable databases and the use of such databases in the present invention are described in more detail below. However, generally, the database of geographic coverage areas is preferably dynamic and capable of being updated by the service center 24. For example, the database preferably contains a version number that can be used to determine if the database is up to date. A suitable version number may be a 16-bit field that allows for a numeric range of 0 to 65535. Assuming the database is updated no more than once per day, this versioning scheme will guarantee unique database versions for at least 179 years. The version number in the wireless communication device 22 could be queried by the service center 24 to see if the database in the device is current. If the unit version number does not match the database repository version number, then the database in the wireless communication device 22 would be out of date and an updating process could be executed.

In one embodiment, the entire database may be updated. A database repository in the service center 24 would instruct the unit to delete the entire database stored in the wireless communication device 22. Thereafter, a new database would be sent to the wireless communication device 22 by a database repository in the service center 24. This type of procedure could be used when there are major changes between the database revisions and the database in the device. In another embodiment, the updating process only includes an incremental change. For instance, when the database has not changed much from a previous version, it will be easier for the database repository in the service center 24 to direct the wireless communication device 22 to make incremental changes to its stored database instead of replacing the entire database. The database repository in the service center 24 could tell the device to add an entry to a field in the database and the pertinent information for an entry in that field. The database repository in the service center 24 could also tell the device to delete an entry from the database by providing the field and the pertinent information for the entry to be deleted. Additionally, the database repository in the service center 24 could tell the wireless communication device 22 to change the version number for its database.

After accessing the database and determining an appropriate transceiver 40, 42, the controller 48 may also configure the wireless communication device 22 so that it can establish a wireless communication link through the selected transceiver 40, 42. For voice calls, there are a number of ways of accomplishing this but, functionally, in one embodiment, the controller 48 may connect the microphone 52 and speaker 54 to the selected transceiver 40, 42 through switches 60a, 60b or other control means.

In another embodiment, the wireless communication device 22 may include further functions specific to the transmission of data messages to the service center 24. Here, the controller 48 may initially select between the first transceiver 40 and the second transceiver 42 based on the location of the wireless communication device 22 and the geographic coverage areas for a particular wireless communication protocol. The controller 48 may further determine whether the call contains high priority data and, if so, the controller 48 may then sequentially select to transmit the message over each of the plurality of bearer services supported in a particular geographic area and according to a sequential order until the message is transmitted to the service center 24. In one embodiment, the sequential order of data bearer services may be based according to geographic availability and a transmission rate of each bearer service. For instance, certain data bearer services within a geographic coverage area could be listed in a sequential order from the highest transmission rate to the lowest transmission rate as follows: (1) GPRS; (2) SMS; and (3) CSD.

Other messages that do not contain data designated as high-priority (such as a request for navigation or traffic information), may then sequentially select to transmit the message over each of the plurality of bearer services within a geographic area according to a different sequential order of bearer services until the message is transmitted to the service center 24. In one embodiment, this sequential order of bearer services may be selected by the user and based according to geographic availability within a coverage area. For instance, certain data bearer services available in a particular geographic area could be listed in a sequential order from cheaper transmission costs to more expensive transmission costs as follows: (1) SMS; (2) CSD; and (3) GPRS.

The wireless communication device 22 may attempt to establish a wireless communication link for a voice call or data message in a number of ways. For instance, the wireless communication device 22 may attempt to establish a wireless communication link in response to one of the user input means 56. One type of user input means 56 may include a voice command received through the microphone 52 that is processed by a voice recognition system 62. Another type of user input means 56 may include a keypad 64 or a application-specific buttons (such as an emergency call (E-Call) button 66 or an information call (I-Call) button 68) that would indicate a user's desire to place a voice call or data message to a particular destination. Additionally, a software application monitoring certain vehicle sensors 70 (such as an airbag deployment sensor) may automatically initiate the transmittal of a data message to the service center 24 upon the occurrence of an event (such as the deployment of the airbag).

In response to receiving the voice call or data message from the wireless communication device 22, the service center 24 or other destination may further act in a number of ways depending on the type of voice call or data contained in the message. For example, if the voice call or data message indicates that the user has an emergency (such as an airbag deployment), the service center 24 may contact an emergency service 34 with the location of the vehicle 26. The emergency service 34 may then send the police, fire brigade, or medical support as needed to the location. If the data contained in the message indicates that the user is simply in need of information (such as navigation, route-guidance, or traffic services), the service center 24 may contact an information service 36 to obtain information related to the request. The service center 24 could then use the obtained information to process the requested service. If the voice call or data message indicates that the user is in need of vehicle service (such as a flat tire), the service center 24 may contact a vehicle service with the location of the vehicle 26. The vehicle service may then send a tow truck or automobile mechanic as needed to the location.

The user output means 58 may include a variety of options such as a speaker 54 or display screen 72. Other user output means 58 may be included depending on the implementation such as warning indicators or alarms. The output means 58 may further provide the user with the ability to receive information from the service center 24 relating to a service request.

The controller 48 is the heart of the wireless communication device 22. A suitable controller 26 for the present invention may includes a digital signal processor (DSP) controller with memory. As described in more detail below, the controller 48 of the present invention preferably executes a number of functional steps. These functional steps may be microcoded signal processing steps that are programmed as operating instructions in the controller 26. The operating instructions may be stored in a computer-readable medium in the controller 26. The flow diagrams described below are merely representative of some of the possible embodiments of the present invention.

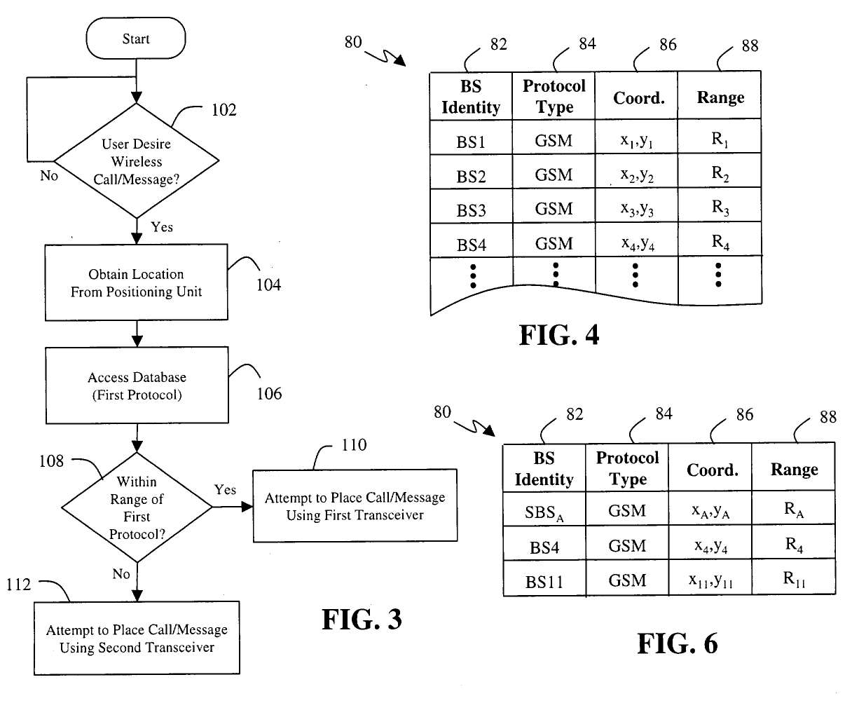

In particular, FIG. 3 shows a flow diagram illustrating one embodiment of a method that may be performed by the wireless communication device 22 in establishing a wireless communication link for voice calls or data messages. In one embodiment, the method includes a decision block 102 that determines whether a user desires to place a wireless call or message through the wireless communication device 22. If it is determined that the user does not want to place a wireless call or message, then the process waits at decision block 102. If it is determined that the user desires to place a wireless call or message, then the process continues to blocks 104 and 106.

At process block 104, the controller 26 obtains the location of the wireless communication device 22 from the positioning unit 44. At process block 106, the controller 26 accesses a database stored in memory 46. This database should include information regarding the geographic coverage areas for at least one of the wireless communication protocols supported by the first transceiver 40 and the second transceiver 42.

For example, FIG. 4 illustrates one embodiment of a database 80 that contains information regarding the geographic coverage areas for at least one wireless communication protocol (GSM). In particular, this database includes information regarding a plurality of cellular base stations that operate according to the wireless communication protocol. The database 80 may have a variety of data fields such as a base station identity field 82 that may identify a particular base station, a wireless protocol type field 84 that may identify the type of protocol of the base station, a coordinate field 86 that may identify the longitude and latitude of the base station, and a range field 88 that may identify a coverage radius of the base station.

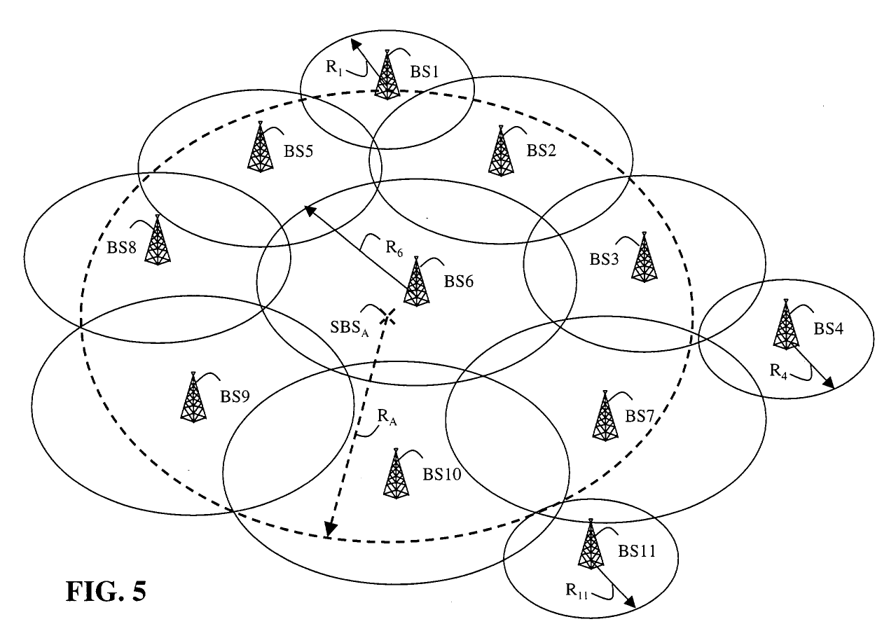

In one embodiment, as illustrated in FIGS. 4 and 5, the database 80 may be organized so that the database 80 contains information for the coverage areas for each base station BS1-B11 that operates under a particular wireless communication protocol. In an effort to reduce the size of the database, as shown in FIGS. 5 and 6, a preferred embodiment includes a database 80 that has one or more super base station SBSA coverage areas that is circular in shape. A super base station coverage area, circular in shape, would represent a combined coverage area from a plurality of cellular base stations. For instance, in FIG. 5, a super base station SBSA coverage area could represent a combined coverage area from cellular base stations BS1-BS3 and BS5-BS10.

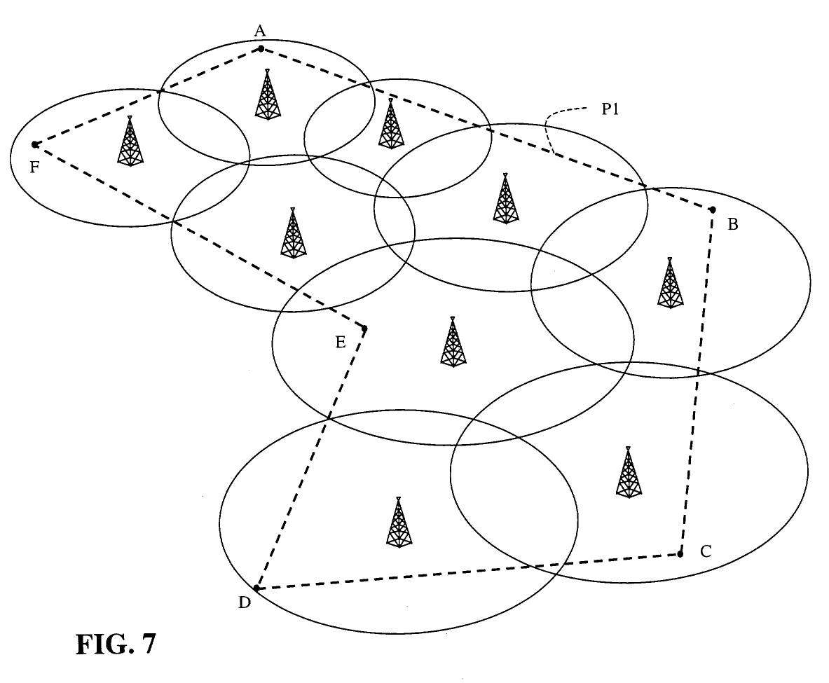

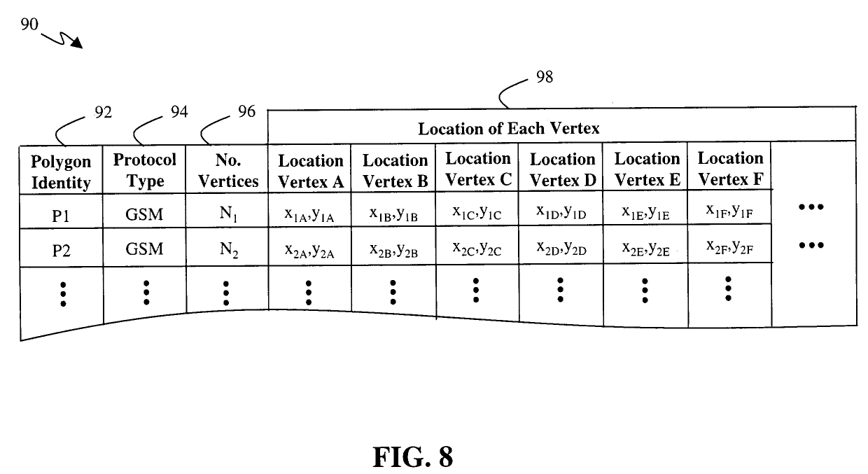

In another embodiment of the present invention, as illustrated in FIGS. 7 and 8, a database 90 could contain information regarding one or more super base station coverage areas that are irregular in shape. The super base station coverage area would represent a combined coverage area from a plurality of cellular base stations. For instance, in FIG. 8, the database 90 could contain a separate list of coverage bounding polygons P1, P2, etc. for situations where overlapping base stations provide a non-circular coverage area. There are different ways to set up a database but, in one embodiment, the database 90 may provide a polygon identity field 92 that may distinguish one polygon coverage area from another, a wireless protocol type field 94 that may identify the type of protocol of the coverage area, a number of vertices field 96 that may identify the number of vertices in the coverage area, and a location for each vertex field 98 that identifies the coordinates (longitude and latitude) of each vertex in the polygon.

An irregular shaped coverage area could be the result of several base stations positioned along a highway. This is further illustrated in FIG. 7 by the polygon P1. For each polygon in the database, the database should contain at least the number of vertices in the polygon (field 96 in database 90) and the location of each vertex in the polygon such as a latitude and longitude (field 98 in database 90). In this case, when analyzing whether a particular point is within the polygon coverage area P1, it would be assumed that the polygon coverage area be constructed by straight lines between vertices and connecting the last vertex in the list with the first vertex in the list. Further, in such an analysis, the polygon must be a single, closed polygon, with no segments connecting vertices crossing. The coverage area could then be defined as the area bounded by the polygon, assuming the list is in clock-wise order. For instance, if someone were walking along the edge of the polygon, going from vertex A to vertex B to vertex C, etc. in the list of vertices defining the polygon, then the area on the right hand side of each defined straight line would be inside the polygon, while the area on the left hand side would be outside the polygon. If a determination is made that a particular location of the wireless communication device 22 is on the right hand side of each defined straight line, then the device would be within the polygon coverage area. This type of right-hand rule relationship for polygons could be used in analyzing whether a particular location of the wireless communication device 22 is within the polygon coverage area or outside the polygon coverage area.

Referring back to FIG. 3, the process continues to decision block 108 where the controller 48 determines whether the wireless communication device 22 is within the range of a first wireless communication protocol. This may be accomplished by having the controller 48 compare the location of the wireless communication device 22 (obtained in process block 104) to the database 80, 90 of information regarding the geographic coverage areas (accessed in process block 106). If the controller 48 determines that the wireless communication device 22 is within the range of a first wireless communication protocol, then the process continues to block 110 where the wireless communication device 22 will attempt to place the call or data message using the first transceiver 40. If the controller 48 determines that the wireless communication device 22 is not within the range of a first wireless communication protocol, then the process continues to block 112 where the wireless communication device 22 will attempt to place the call or data message using the second transceiver 42.

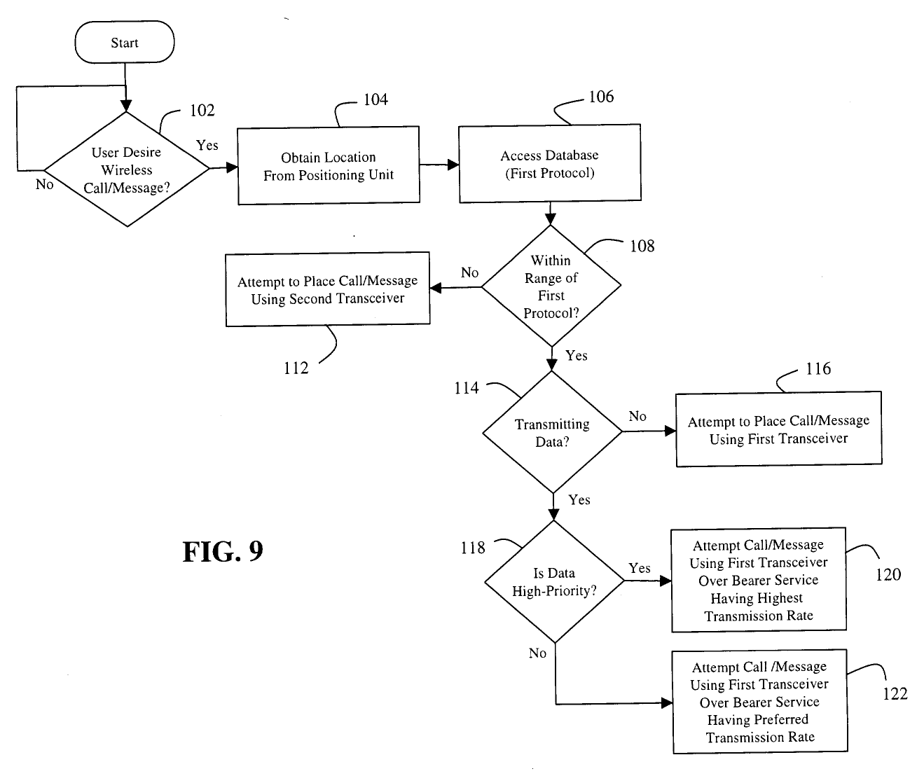

FIG. 9 shows a flow diagram illustrating another embodiment of a method that may be performed by the wireless communication device 22 in establishing a wireless communication link for voice calls or data messages. In this embodiment, the method includes further considerations for the transmittal of data messages.

In particular, the method includes a decision block 102 that determines whether a user desires to place a wireless call or message through the wireless communication device 22. If it is determined that the user does not want to place a wireless call or message, then the process waits at decision block 102. If it is determined that the user desires to place a wireless call or message, then the process continues to blocks 104 and 106.

At process block 104, the controller 26 obtains the location of the wireless communication device 22 from the positioning unit 44. At process block 106, the controller 26 accesses a database stored in memory 46. This database should include information regarding the geographic coverage areas for at least one of the wireless communication protocols supported by the first transceiver 40 and the second transceiver 42. In this embodiment, however, the database includes further information regarding the coverage area for using certain types of data bearer services.

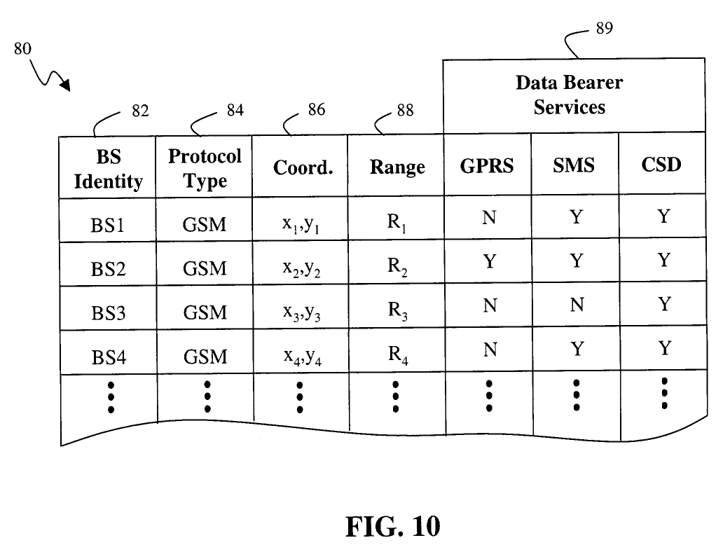

For example, FIG. 10 illustrates one embodiment of a database 80 that contains information regarding the geographic coverage areas for at least one wireless communication protocol (GSM). In particular, this database includes information regarding a plurality of cellular base stations that operate according to the wireless communication protocol. The database 80 may have a variety of data fields such as a base station identity field 82 that may identify a particular base station, a wireless protocol type field 84 that may identify the type of protocol of the base station, a coordinate field 86 that may identify the longitude and latitude of the base station, a range field 88 that may identify a coverage radius of the base station, and a data bearer service field 89 that may identify the types of data bearer services supported by the base station.

In one embodiment, as illustrated in FIG. 10, the database 80 may be organized so that the database 80 contains information for the coverage areas for each base station BS1-B11 that operates under a particular wireless communication protocol. In an effort to reduce the size of the database, a preferred embodiment includes a database 80 that has one or more super base station SBS_{A} coverage areas that is circular in shape similar to the one shown in FIG. 5. In another embodiment of the present invention, the database could contain information regarding one or more super base station coverage areas that are irregular in shape similar to the one shown in FIG. 7.

Referring back to FIG. 9, the process continues to decision block 108 where the controller 48 determines whether the wireless communication device 22 is within the range of a first wireless communication protocol. This may be accomplished by having the controller 48 compare the location of the wireless communication device 22 (obtained in process block 104) to the database 80 of information regarding the geographic coverage areas (accessed in process block 106). If the controller 48 determines that the wireless communication device 22 is not within the range of a first wireless communication protocol, then the process continues to block 112 where the wireless communication device 22 will attempt to place the call or data message using the second transceiver 42. In this embodiment, if the controller 48 determines that the wireless communication device 22 is within the range of a first wireless communication protocol, then the process continues to decision block 114.

At decision block 114, the method includes a determination of whether the call is for the transmission of data. If not, the wireless communication device 22 will then proceed to process block 116 to attempt to place the call using the first transceiver 40. If the call is for the transmission of data, then the process may further proceed to decision block 118.

At decision block 118, a determination may be made whether the data message is high-priority. In making the determination whether the data message is high-priority, the decision may include a consideration of the application that generated the message such as an emergency call or the checking of data within the message to see if the message has been identified as high-priority data.

If the data message is high-priority, then the method will proceed to process block 120 where the controller 48 sequentially selects to transmit the data message over a plurality of bearer services. The sequence of selecting each bearer service may be according to a first sequential order of bearer services obtained from a configuration file stored in memory of the controller 48. As mentioned above, for example, the first sequential order of bearer services for high-priority data may be a list of bearer services in an order from the highest transmission rate to the lowest transmission rate. In one embodiment, where the wireless communication device 22 is capable of transmitting data messages over bearer services GPRS, SMS, and CSD, the sequential order may be as follows: the first bearer service may be GPRS, the second bearer service may be SMS, and the third bearer service may be CSD. However, the order of bearer services may further include a consideration of whether a particular bearer service is accessible in a particular geographic coverage area. This may be done by having the controller 48 compare the location of the wireless communication device 22 (obtained in process block 104) to the database 80 of information regarding the geographic coverage areas (accessed in process block 106), including data field 89.

Referring back to decision block 118, if there is a determination that the data in the message is not high-priority, then the method proceeds to process block 122. An example of data in a message that is not high-priority may include those messages generated by an information call application. However, the exact designations are implementation specific. At process block 122, the method attempts to transmit the data message over a first bearer service. Here, the first bearer service may be selected from a second sequential order of bearer services that relates to non-high-priority data configured by the user. For example, as mentioned above, data that is not high-priority may have a different sequential order of bearer services that ranks the bearer services from cheaper transmission costs to more expensive transmission costs. Nevertheless, process block 122 should further consider whether a particular bearer service is accessible in a particular geographic coverage area. This may be done by having the controller 48 compare the location of the wireless communication device 22 (obtained in process block 104) to the database 80 of information regarding the geographic coverage areas (accessed in process block 106), including data field 89.

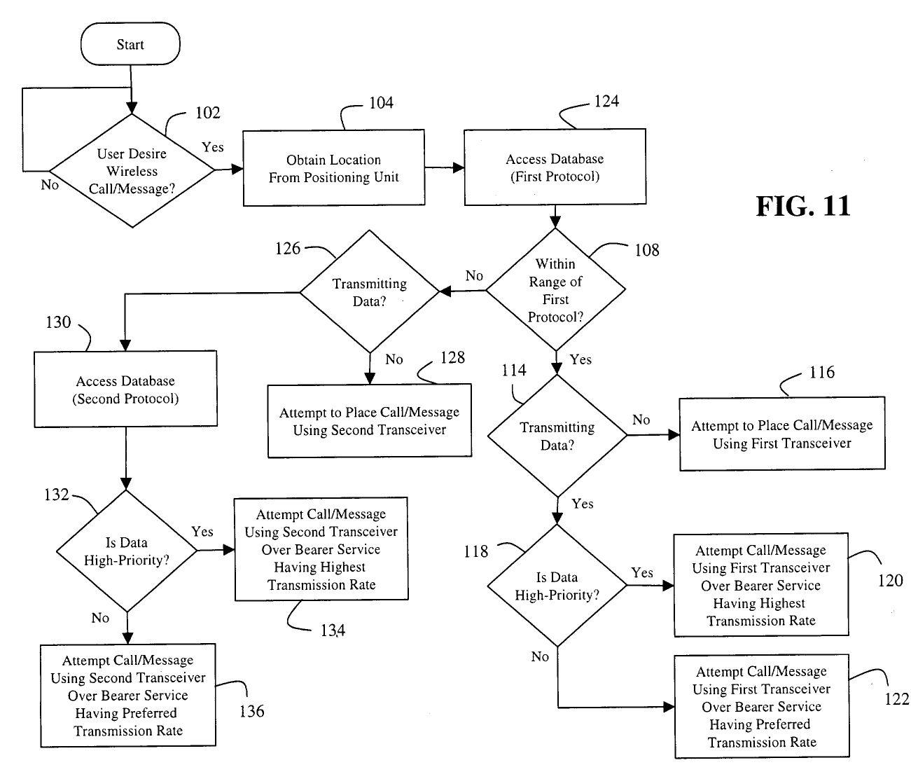

FIG. 11 shows a flow diagram illustrating a further embodiment of a method that may be performed by the wireless communication device 22 in establishing a wireless communication link for voice calls or data messages. In this embodiment, the method includes further considerations for the transmittal of data messages and for a database containing information on more than one wireless communication protocol.

In particular, the method includes a decision block 102 that determines whether a user desires to place a wireless call or message through the wireless communication device 22. If it is determined that the user does not want to place a wireless call or message, then the process waits at decision block 102. If it is determined that the user desires to place a wireless call or message, then the process continues to blocks 104 and 124.

At process block 104, the controller 26 obtains the location of the wireless communication device 22 from the positioning unit 44. At process block 124, the controller 26 accesses a database stored in memory 46. The database in this embodiment, however, includes information regarding the geographic coverage areas for the two wireless communication protocols supported by the first transceiver 40 and the second transceiver 42. The database further includes information regarding the coverage area for using certain types of data bearer services.

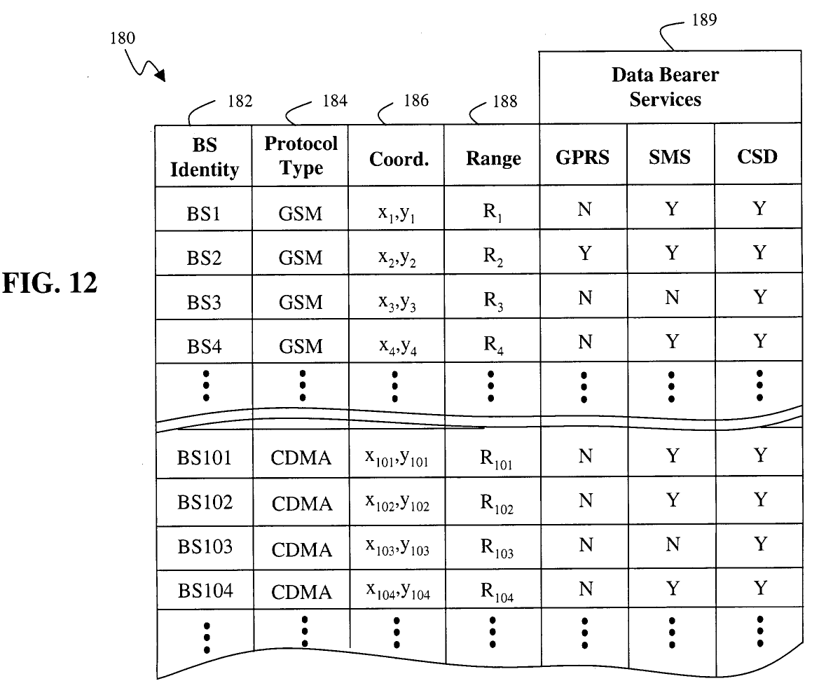

For example, FIG. 12 illustrates one embodiment of a database 180 that contains information regarding the geographic coverage areas for two wireless communication protocols (GSM and CDMA). In particular, this database includes information regarding a plurality of cellular base stations that operate according to the two wireless communication protocols. The database 180 may have a variety of data fields such as a base station identity field 182 that may identify a particular base station, a wireless protocol type field 184 that may identify the type of protocol of the base station, a coordinate field 186 that may identify the longitude and latitude of the base station, a range field 188 that may identify a coverage radius of the base station, and a data bearer service field 189 that may identify the types of data bearer services supported by the base station.

In one embodiment, as illustrated in FIG. 12, the database 180 may be organized so that the database 180 contains information for the coverage areas for each base station BS1-B11 that operates under a particular wireless communication protocol. In an effort to reduce the size of the database, a preferred embodiment includes a database 180 that has one or more super base station SBS_{A} coverage areas that is circular in shape similar to the one shown in FIG. 5. In another embodiment of the present invention, the database could contain information regarding one or more super base station coverage areas that are irregular in shape similar to the one shown in FIG. 7.

Referring back to FIG. 11, the process continues to decision block 108 where the controller 48 determines whether the wireless communication device 22 is within the range of a first wireless communication protocol (such as GSM). This may be accomplished by having the controller 48 compare the location of the wireless communication device 22 (obtained in process block 104) to one of the wireless communication protocols in database 180 (accessed in process block 124). If the controller 48 determines that the wireless communication device 22 is within the range of a first wireless communication protocol, then the process continues to decision block 114 similar to that described above in relation to FIG. 9. In this embodiment, however, if the controller 48 determines that the wireless communication device 22 is not within the range of a first wireless communication protocol, then the process continues to decision block 126.

At decision block 126, a determination may be made whether the call is for the purpose of transmitting data. If not, then the process may continue to process block 128. If the call is for the purpose of transmitting data, then the method may further proceed to process block 130. At process block 130, the controller 48 accesses the database 180 again but with respect to the second wireless communication protocol (such as CDMA). This will inform the controller 48 about the particular bearer services supported within a geographic coverage area. The process proceeds to decision block 132.

At decision block 132, a determination may be made whether the data message is high-priority. In making the determination whether the data message is high-priority, the decision may include a consideration of the application that generated the message such as an emergency call or the checking of data within the message to see if the message has been identified as high-priority data.

If the data message is high-priority, then the method will proceed to process block 134 where the controller 48 sequentially selects to transmit the data message over a plurality of bearer services. The sequence of selecting each bearer service may be according to a first sequential order of bearer services obtained from a configuration file stored in memory of the controller 48. As mentioned above, for example, the first sequential order of bearer services for high-priority data may be a list of bearer services in an order from the highest transmission rate to the lowest transmission rate. In one embodiment, where the wireless communication device 22 is capable of transmitting data messages over bearer services GPRS, SMS, and CSD, the sequential order may be as follows: the first bearer service may be GPRS, the second bearer service may be SMS, and the third bearer service may be CSD. However, the order of bearer services may further include a consideration of whether a particular bearer service is accessible in a particular geographic coverage area. This may be done by having the controller 48 compare the location of the wireless communication device 22 (obtained in process block 104) to the database 180 of information regarding the geographic coverage areas (accessed in process block 130), including data field 189.

Referring back to decision block 132, if there is a determination that the data in the message is not high-priority, then the method may proceed to process block 136. An example of data in a message that is not high-priority may include those messages generated by an information call application. However, the exact designations are implementation specific. At process block 136, the method attempts to transmit the data message over a first bearer service. Here, the first bearer service may be selected from a second sequential order of bearer services that relates to non-high-priority data configured by the user. For example, as mentioned above, data that is not high-priority may have a different sequential order of bearer services that ranks the bearer services from cheaper transmission costs to more expensive transmission costs. Nevertheless, process block 136 should further consider whether a particular bearer service is accessible in a particular geographic coverage area. This may be done by having the controller 48 compare the location of the wireless communication device 22 (obtained in process block 104) to the database 80 of information regarding the geographic coverage areas (accessed in process block 130), including data field 189.

What has been, described is a device and method in a wireless communication device having more than one transceiver operating under different protocol technologies. The device and method is advantageous to a situation where a controller in the device needs to quickly select a transceiver to use for placing an outgoing call or transmitting a data message. The present invention utilizes a database of service coverage locations for at least one of the protocol technologies (a preferred technology) in conjunction with its current geographic position to determine if a call or data message should be attempted using the preferred technology transceiver. If the current location of the device is not within the preferred service coverage area, then the secondary transceiver can be used immediately to place the call instead of waiting to make a call or message attempt with the preferred transceiver. This is especially important for emergency calls, where faster connection times relate to faster response times by emergency personnel. Moreover, the device and method of the present invention saves power by preventing an attempted call or message through a transceiver that operates under a protocol that is not supported in a particular geographic area. This advantage is especially important to portable wireless communication devices. The above description of the present invention is intended to be exemplary only and is not intended to limit the scope of any patent issuing from this application. The present invention is intended to be limited only by the scope and spirit of the following claims.

What is claimed is:

1. A wireless communication device comprising:
a first transceiver that operates according to a first wireless communication protocol;
a second transceiver that operates according to a second wireless communication protocol;
a positioning unit for determining a location of the wireless communication device;
a memory that stores a database of the geographic coverage areas for communicating with remote base stations that operate according to the first wireless communication protocol; and
a controller that selects between the first transceiver and the second transceiver when initially attempting to establish a wireless communication link;
wherein the selection between the first transceiver and the second transceiver is based on the determined location of the wireless communication device from the positioning unit and the geographic coverage areas in the database that is stored in the memory.

2. The wireless communication device in claim 1, wherein the geographic coverage areas in the database includes at least one super coverage area that is circular in shape, the super coverage area being representative of a combined coverage area from a plurality of cellular base stations that operate according to a first wireless communication protocol.

3. The wireless communication device in claim 1, wherein the geographic coverage area in the database includes at least one super coverage area that is irregular in shape, the super coverage area being representative of a combined coverage area from a plurality of cellular base stations that operate according to a first wireless communication protocol.

4. The wireless communication device in claim 1, wherein the geographic coverage areas in the database stored in the memory are capable of being updated by a remote service center.

5. The wireless communication device in claim 1, wherein the positioning unit comprises a global positioning system (GPS) receiver.

6. The wireless communication device in claim 1, wherein the controller further determines whether a user is attempting to place a voice call or transmit a data message.

7. The wireless communication device in claim 6, wherein the database stored in the memory further includes information regarding the geographic coverage areas for communicating data messages over a plurality of data bearer services, the controller further selecting at least one data bearer service based on the determined location of the wireless communication device from the positioning unit and the geographic coverage areas in the database that is stored in the memory.

8. The wireless communication device in claim 7, wherein the controller determines whether the data message includes high-priority data if the controller determines that the user is attempting to transmit a data message.

9. The wireless communication device in claim 8, wherein the selection of at least one data bearer service by the controller is further based on the highest available transmission rate within a geographic coverage area if the data message is determined to include high-priority data.

10. The wireless communication device in claim 1, wherein the first transceiver is permanently housed within a vehicle and the second transceiver is a separate portable wireless unit that is connected to the vehicle.

11. A wireless communication device comprising:
a first and second transceiver, each of the first and second transceivers operating according to a different wireless communication protocol;
a positioning unit for determining a location of the wireless communication device;
a memory that stores information regarding the geographic coverage areas for communicating with remote base stations that operate according to at least one of the wireless communication protocols; and
a means for selecting between the first and second transceivers when the wireless communication device needs to establish a wireless communication link, the selection means based on the location of the wireless communication device from the positioning unit and based on the information stored in the memory regarding the geographic coverage areas for communicating with remote base stations that operate according to at least one of the wireless communication protocols.

12. The wireless communication device in claim 11, wherein the information stored in memory regarding the geographic coverage areas includes information regarding at least one super coverage area that is circular in shape, the super coverage area being representative of a combined coverage area from a plurality of cellular base stations that operate according to at least one of the wireless communication protocols.

13. The wireless communication device in claim 11, wherein the information stored in memory regarding the geographic coverage areas includes information regarding at least one super coverage area that is irregular in shape, the super coverage area being representative of a combined coverage area from a plurality of cellular base stations that operate according to at least one of the wireless communication protocols.

14. The wireless communication device in claim 11, wherein the geographic coverage areas stored in the memory are capable of being updated by a remote service center.

15. The wireless communication device in claim 11, wherein the positioning unit comprises a global positioning system (GPS) receiver.

16. The wireless communication device in claim 11 further comprising a means for determining whether a user is attempting to place a voice call or transmit a data message.

17. The wireless communication device in claim 16, wherein the memory further stores information regarding the geographic coverage areas for communicating data messages over a plurality of data bearer services, the wireless communication device further comprising a means for selecting between a plurality of data bearer services based on the location of the wireless communication device from the positioning unit and based on the information stored in memory regarding the geographic coverage areas for communicating data messages over a plurality of data bearer services.

18. The wireless communication device in claim 17 further comprising a means for determining whether the data message includes high-priority data if it is determined that the user is attempting to transmit a data message.

19. The wireless communication device in claim 18, wherein the means for selecting between a plurality of data bearer services is further based on the highest available transmission rate within a geographic coverage area if the data message is determined to include high-priority data.

20. The wireless communication device in claim 11, wherein the first transceiver is permanently housed within a vehicle and the second transceiver is a separate portable wireless unit that is connected to the vehicle.

21. A method in a wireless communication device, the wireless communication device having a first transceiver and a second transceiver, each of the first and second transceivers operating according to a different wireless communication protocol, the method comprising the steps of:
determining whether a wireless communication link needs to be established by the wireless communication device;
determining the location of the wireless communication device when it is determined that a wireless communication link needs to be established;
accessing a memory in the wireless communication device to obtain information regarding geographic coverage areas for communicating with remote base stations that operate according to at least one of the wireless communication protocols; and
selecting to establish the wireless communication link through either the first transceiver or the second transceiver based on the location of the wireless communication device and based on the information regarding the geographic coverage areas for communicating with the remote base stations that operate according to at least one of the wireless communication protocols.

22. The method in claim 21, wherein the information regarding the geographic coverage areas includes information regarding at least one super coverage area that is circular in shape, the super coverage area being representative of a combined coverage area from a plurality of cellular base stations that operate according to at least one of the wireless communication protocols.

23. The method in claim 21, wherein the information regarding the geographic coverage areas includes information regarding at least one super coverage area that is irregular in shape, the super coverage area being representative of a combined coverage area from a plurality of cellular base stations that operate according to at least one of the wireless communication protocols.

24. The method in claim 21, wherein the memory in the wireless communication device is capable of being by a remote service center with revised information regarding the geographic coverage areas for communicating with remote base stations that operate according to at least one of the wireless communication protocols.

25. The method in claim 21, wherein the step of determining the location of the wireless communication device is done by a positioning unit in the wireless communication device, the positioning unit having at least a global positioning system (GPS) receiver.

26. The method in claim 21 further comprising a step of determining whether a user is attempting to place a voice call or transmit a data message.

27. The method in claim 26 further comprising the steps of:
accessing the memory in the wireless communication device to obtain information regarding geographic coverage areas for communicating data messages over a plurality of data bearer services; and
selecting between a plurality of data bearer services based on the location of the wireless communication device and based on the information regarding the geographic coverage areas for communicating data messages over a plurality of data bearer services.

28. The method in claim 27 further comprising a step of determining whether the data message includes high-priority data if it is determined that the user is attempting to transmit a data message.

29. The method in claim 27, wherein the step of selecting between a plurality of data bearer services is further based on the highest available transmission rate within a geographic coverage area if the data message is determined to include high-priority data.

30. A wireless communication device comprising:
at least one transceiver that operates according to a first bearer service and a second bearer service;
a positioning unit for determining a location of the wireless communication device;
a memory that contains information relating to geographic coverage areas for at least the first bearer service; and
a controller capable of selecting between the first bearer service and the second bearer service when attempting to transmit a data message based on the determined location of the wireless communication device from the positioning unit and based on the information in the memory relating to the geographic coverage areas for at least the first bearer service.

31. The wireless communication device in claim 30, wherein the controller is further capable of determining whether the data message contains high-priority data, the controller selecting between the first bearer service and the second bearer service when the controller determines that the data message contains high-priority data.

32. The wireless communication device in claim 31, wherein the controller is further capable of determining whether the data message contains high-priority data, the controller selecting between the first bearer service and the second bearer service based on the highest available transmission rate within a geographic coverage area if the data message is determined to contain high-priority data.
